(19) United States
(12) Patent Application Publication
(10) Pub. No.: US 2009/0150837 A1
(43) Pub. Date: Jun. 11, 2009

(54) CHECKING A CIRCUIT LAYOUT FOR A SEMICONDUCTOR APPARATUS

(75) Inventors: Max E. Mergenthaler, Duetschland (DE); Andrea Zuckerstaetter, Deutschland (DE)

Correspondence Address: DICKSTEIN SHAPIRO, LLP, 1177 AVENUE OF THE AMERICAS, NEW YORK, NY, 10036-2714, US

(73) Assignee: Qimonda AG, Munich (DE)

(21) Appl. No.: 11/719,512

(22) PCT Filed: Oct. 7, 2005
(86) PCT No.: PCT/EP05/10834

§ 371 Date: Dec. 17, 2007

(30) Foreign Application Priority Data
Nov. 17, 2004 (DE) 102004055457.9

(51) Int. Cl. G06F 17/50

(52) U.S. Cl. 716/5

(57) ABSTRACT

Method for checking a circuit layout for a semiconductor apparatus, including:
(a) recording a circuit layout which has been created;
(b) carrying out a test to determine whether predeterminable conditions are satisfied in the circuit layout;
(c) if at least one predeterminable condition is not satisfied,
   (c1) determining position data for the at least one circuit part of the circuit layout for which at least one predeterminable condition is not satisfied; and
(d) carrying out a simulation for the at least one circuit part determined in step (c), in order to obtain a simulation result.

### CROSS-REFERENCE TO RELATED APPLICATION

This application is a nation stage of International Patent Application Serial No. PCT/EP2005/010834, filed Dec. 7, 2005, which published in German on May 26, 2006 as WO/2006/053608, and is incorporated herein by reference in its entirety.

### BACKGROUND

The invention relates to a method, to a computer program product, and to an apparatus for checking a circuit layout for a semiconductor apparatus.

Methods are known for the development and creation of layouts of semiconductor apparatuses in which a circuit layout that has been created by a user or layouter is checked to determine whether predeterminable conditions are satisfied within the circuit layout. A check such as this is also referred to as a Design Rule Check (DRC), in which design rule infringements are determined. The determined design rule infringements are emitted as error messages to the user, and the user uses the error messages that have been emitted to assess whether the circuit layout must be changed, or whether the circuit layout can be retained despite the design rule infringement. However, in many cases, it is difficult to decide whether the circuit layout need or need not be changed. In particular, it is frequently difficult to assess whether the determined design rule infringements will or will not adversely affect correct operation of the semiconductor apparatus for which the layout that has been developed will be used.

The present invention therefore provides a method, a computer program product and an apparatus for checking a circuit layout for a semiconductor apparatus, which allow a circuit layout to be created in a better, simpler manner.

### BRIEF DESCRIPTION OF THE DRAWINGS

Further features, objects and advantages of the present invention will become clear from the following description of preferred embodiments of the invention, with reference to the drawings, in which:

FIG. 1 shows a schematic view of the design procedure for a semiconductor apparatus; and

FIG. 2 shows a schematic view of the step of “layout” from FIG. 1.

### DESCRIPTION OF THE INVENTION

According to the invention, a method for checking a circuit layout, which has been created essentially manually by a user or layouter, for a semiconductor apparatus comprises the following steps:
(a) a circuit layout which has been created is recorded;
(b) a test is carried out, in particular automatically, to determine whether predeterminable conditions are satisfied in the circuit layout;
(c) if at least one predeterminable condition is not satisfied,
   (c1) the position data or coordinates for at least one circuit part, region, point or section of the circuit layout for which at least one predeterminable condition is not satisfied is determined; and
(d) a simulation is carried out for at least one circuit part determined in step (c), in order to obtain a simulation result.

The method may also comprise a step of emission of the simulation result.

The process of carrying out a simulation provides the user with additional information as to whether the respective design rule infringement would result in a significant adverse effect on the operation of the semiconductor apparatus. It is thus possible to determine, and if necessary to rectify, a possibly critical point in the circuit layout at an early stage in the development of a semiconductor apparatus.

The circuit layout recorded in step (a) is, in particular, a circuit layout which has been created using a circuit design.

The predeterminable conditions are, in particular, design rules which can be specified and, for example, define the positions of individual circuit elements with respect to one another, the distance between circuit elements, the size of a contact via, the size of a diffusion region in a transistor, or the like.

Step (c) preferably furthermore comprises the following step:
(c2) the position data is emitted to a user, in particular by indication or marking of the respective circuit part on a monitor or on some other display medium.

In particular, it is possible to provide for those circuit parts which do not satisfy a predeterminable condition to be displayed in the circuit layout on a monitor to the user. The user can therefore easily locate the respective circuit part in the circuit layout.

Step (c) preferably furthermore comprises the following step:
(c3) an error message is emitted which preferably indicates which of the predeterminable conditions is not satisfied by the circuit part.

For example, the error message can indicate which design rule is not satisfied by the circuit part.

Step (c) preferably furthermore comprises the following additional step:
(c4) classifying or grouping of errors in predeterminable error classes or groups.

In this case, errors of the same type are, in particular, each associated with a predeterminable error class.

In particular, steps (c1) to (c4) can be carried out in any desired sequence.

Step (c) can be carried out for essentially all those parts of the circuit layout for which at least one predeterminable condition is not satisfied.

Thus, in particular, it is possible to locate, and preferably to indicate to the user, essentially all of the circuit parts for which it has been found that a predeterminable condition is not satisfied.

Step (d) is preferably carried out essentially automatically, and/or directly following completion of step (c).

In this case, it is possible to provide for step (d) to be carried out for all the circuit parts determined in step (c). Alternatively, it is possible to provide for step (d) to be carried out only for circuit parts which do not satisfy a predeterminable condition.

Step (d) preferably comprises the following step:

(d1) a predeterminable input from a user is read;
(d2) the simulation is carried out using the user input.

The simulation is therefore not carried out until the user has made a predeterminable input.

The user input is preferably a selection of at least one circuit part determined in step (c), and the simulation is carried out for the selected part or parts.

In particular, the user can select those circuit parts for which a simulation should be carried out.

Alternatively, the user input is a selection of at least one error class and the simulation is carried out for those parts of the circuit layout which are associated with the selected error class or classes. A representative of an error class is also preferably defined (DETAIL) in step (c4), and the simulation is carried out for the representative of the selected error class or classes.

Inputting of the error class which is intended to be simulated and simulation of in each case only one representative of the respective error class makes it possible to reduce the computation power and time required for the simulation. In particular, it can generally be assumed that the simulation result will be essentially the same for the errors in one error class.

Step (d) furthermore may comprise the following steps:
(d3) a simulation area which essentially contains the circuit part determined in step (c) is selected;
(d4) a simulation is carried out on the simulation area selected in step (d3).

The simulation area is therefore used to form a type of “window” around that circuit part which does not satisfy a predeterminable condition. The use of the selected simulation area for the simulation makes it possible in particular to simulate the interaction of that circuit part which does not satisfy the predeterminable condition with other circuit elements in its vicinity.

Step (d3) is preferably carried out automatically, and the size and/or position of the simulation area can furthermore preferably be preset.

The size of the simulation area may be defined in particular by a lateral and longitudinal extent of an essentially rectangular area. The position of the simulation area is preferably defined in order to allow the circuit part to be simulated in as valid a form as possible. For example, it is possible to provide for the size of the simulation area to in each case assume a predeterminable value, and for the simulation area in each case to be positioned such that the circuit part to be simulated is arranged essentially in the center of the simulation area.

Alternatively, step (d3) comprises a step of reading a user input, by means of which the size and/or position of the simulation area is defined.

In particular, in this case, the user input, for example “draw a window” by means of a pointing apparatus such as a mouse can be used to define the size and/or position of the simulation area. However, it is also possible to provide for the capability to preset the size of the simulation area and for the user input to comprise indication of a position around which the simulation area should be formed. As an alternative to this, it is possible to provide for the user to be able to define the size of the simulation area. In this case, the position can be preset.

Steps (a) to (d) are preferably carried out essentially automatically while the layout is being created.

For example, it is possible to provide for steps (a) to (d) each to be carried out when the user makes a change to the layout. Alternatively or additionally, it is possible for steps (a) to (d) to be carried out when predeterminable areas of the layout have been completed.

The method may furthermore comprise a step of reading a user input which indicates that a check should be carried out, and steps (a) to (d) can be carried out in response to the user input.

The user can therefore define whether steps (a) to (d) should be carried out. This may be done during the creation process, or else after completion of the layout.

The method preferably comprises the following steps:

(e) a change to the circuit layout by the user is recorded; and
steps (b) to (d) are then carried out.

In particular, the user can change the circuit layout using the simulation result determined in step (d). This results in a type of loop in which a check is carried out after every change to the circuit layout.

Steps (a) to (e) are preferably carried out using the circuit layout in a first data format, and the method comprises the following further step:
(f) the circuit layout that is being created is prepared for conversion of the circuit layout to a second data format, which is used for further processing.

The first data format is, in particular, a data format in which the circuit layout can be changed easily. In contrast to this, the second data format is a data format which allows the circuit layout to be changed only to a highly restricted extent. The second data format is used in particular for automatic correction of the circuit layout during a lithography simulation.

Furthermore, according to the invention, a computer program product is provided in order to check a circuit layout for a semiconductor apparatus, which product comprises program parts for carrying out a method according to the invention or a preferred embodiment of it.

Furthermore, according to the invention, an apparatus is provided for checking a circuit layout for a semiconductor apparatus, with the apparatus comprising:
a device for recording of a circuit layout that has been created;
a device for carrying out a test to determine whether predeterminable conditions are satisfied in the circuit layout;
a device for determination of the position data of at least one circuit part of the circuit layout for which at least one predeterminable condition is not satisfied; and
a device for carrying out a simulation for at least one determined circuit part, in order to obtain a simulation result.

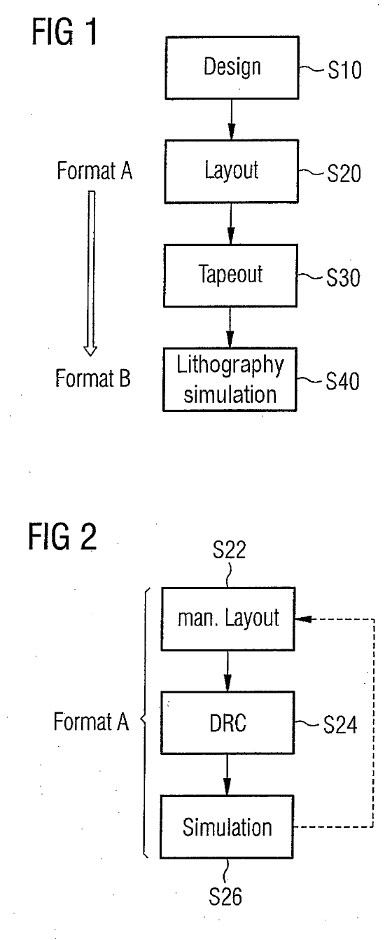

The procedure for the various processing steps in the development of a semiconductor apparatus will be described first of all with reference to FIG. 1.

During the development of a semiconductor apparatus, the desired circuit is first of all created graphically, using the conventional electronics symbols, in a design step (S10). The individual circuit element symbols and their connections to one another are therefore shown in the circuit design.

In a next layout step (S20), the symbolic representation of the circuits, the design, is transferred to the physical characteristics of an actual circuit. All of the individual parts of the circuit are for this purpose plotted in graphical form, in accordance with suitable design rules. For example, transistors are shown accurately with their diffusion regions, the gate and the connections to the surrounding area. The layout provides graphical representation of the actual arrangement of the switching elements on the semiconductor. The design is generally manually converted to a layout with the aid of drawing programs by a user or layouter.

In particular, predeterminable design rules must be complied with in the layout process. The design rules are, in particular, predeterminable conditions and relationships between the individual circuit elements on the semiconductor. By way of example, design rules indicate what the minimum separation must be between individual circuit elements, how large a diffusion region must be in a transistor, or the minimum separations from metal.

The layout is checked against the predeterminable design rules with the aid of methods. This will be described in detail later with reference to FIG. 2.

Once the layout has been checked and has been released by the layouter, the tapeout step (S30) is carried out. During this process, the layout, which is in a first data format, is converted to a second data format. The second data format is preferably the gds-Format (“graphical display streamer” format). The layout is created and changed in a simple manner in the first format. In particular, the second format contains fewer attributes. Furthermore, in particular, the circuit arrangement can be changed only in accordance with predeterminable rules in the second format. In particular, these rules use the number of the layer and the data type. The changes to the configuration of the circuit in the second format are carried out automatically, and can be influenced by a user only to a very restricted extent.

The tapeout is followed by a lithography simulation (S40), in which the feasibility of manufacturing the designed circuit is checked. An optical proximity check (OPC) is carried out, in particular, during this process.

Once all of the required tests have been successfully completed, lithography masks are created for manufacture of the semiconductor apparatus.

The layout step S20 from FIG. 1 will be described in detail in the following text, with reference to FIG. 2.

First of all, in step S22, the layout is created essentially “manually” by a user or layouter. In this case, this is based on the circuit design, which has been created in advance. During the layout process, the circuit which has been developed by a designer is transferred to the physical characteristics. The layout is preferably created using layout programs, with the aid of which the layouter records the individual parts of the circuit graphically in accordance with predetermined design rules.

Once the layout has been created, the created layout is subjected to a check to determine whether predeterminable design rules have or have not been infringed. This is done in particular by means of a so-called Design Rule Check (DRC) (step S24). During this process, a check is carried out to determine whether the predeterminable design rules, such as the separation between individual elements, the thickness and size of specific areas, etc., are satisfied. Circuit layout parts and areas for which at least one design rule is not satisfied are then indicated to the user. This can be done, for example, by means of an error list. Alternatively, the points determined can be displayed in the layout view.

Process window simulation is then carried out for those points in the circuit layout for which a design rule infringement has been found (step S24). The layouter can now use the simulation result to make a better statement as to whether the determined design rule infringement would represent a significant adverse effect on operation during use of the actual semiconductor apparatus. The layouter can use this information to appropriately adapt the layout (this is represented by the dashed line in FIG. 2). For example, the distance between two elements can be increased.

A design rule check (step S24) and a simulation (step S26) can then be carried out once again. This procedure can be repeated until the layouter releases the circuit layout for the tapeout (S30).

In alternative embodiments, it is possible to provide for the design rule check DRC (step S24) to be carried out, so to speak, “on-line” during the layout design process. This means that the design rule check is essentially carried out with every change to the layout, and error messages are emitted as appropriate. Furthermore, it is possible to provide for the design rule check to be carried out once individual areas of the layout have been completed. Alternatively or additionally, the design rule check can be carried out after completion of the entire layout, in order to carry out a final check of the layout before the tapeout step S30. In the last two cases, the design rule check is started by a user input.

The simulation step S2.6 may, for example, be carried out for all circuit parts for which a design rule infringement has been determined. As an alternative to this, it is possible to provide for the layouter to select specific circuit parts for which the simulation should be carried out. By way of example, these may be circuit parts for which the design rule infringement is particularly critical.

It is also possible to provide for the design rule infringements to be classified in error classes. Error classes such as these are preferably created during the design rule check. In a situation such as this, it is possible to provide for the simulation to in each case be carried out for one representative in one error class. It is generally sufficient to in each case simulate only one circuit part which represents one error class.

The simulation of the circuit part for which a design rule infringement has been found can be carried out in various ways. For example, an area which surrounds the circuit part can be selected, and the entire selected area can be simulated. The area may be selected automatically or by a user input. In particular, the position and/or size of the simulation area are defined in this case. This allows a so-called “simulation window” to be defined, within which a simulation is carried out.

In particular, the size of the simulation area may be defined by a lateral and longitudinal extent of an essentially rectangular area, a so-called “bounding box”. The position of the simulation area is preferably defined in order to allow the circuit part to be simulated in as valid a manner as possible. For example, it is possible to provide for the size of the simulation area to in each case assume a predeterminable value, and for the simulation area to in each case be positioned such that the circuit part to be simulated is arranged essentially in the center of the simulation area.

If the simulation area is selected automatically, it is advantageous if the size and/or position of the simulation area can be preset.

If the simulation area is selected by a user input, for example “drawing a window”, with a pointing apparatus such as a mouse, the size and the position of the simulation area may be defined. However, it is also possible to provide for the capability to preset the size of the simulation area, and for the user input to be made by indicating a position around which the simulation area is intended to be formed. As an alternative to this, it is possible to provide for the user to be able to define the size of the simulation area. In this case, the position can be preset.

In summary, it can be stated that, in particular, a method is provided in which a simulation step is provided during the creation of the circuit layout. In particular, this simulation step is carried out before the step of tapeout for the circuit layout. The provision of the simulation step allows errors to be discovered at an early stage, allowing time and therefore costs to be saved. In addition to the information that design rule infringements are present, the provision of the stimulation step provides the layout with information as to whether the respected simulated design rule infringement would significantly adversely affect the operation of the semiconductor apparatus. The layouter can use this information to decide more easily whether the circuit layout need or need not be changed appropriately.

1-19. (canceled)

20. A method for checking a circuit layout of a semiconductor apparatus, comprising:
(a) recording a circuit layout which has been created;
(b) carrying out a test to determine whether predeterminable conditions are satisfied in the circuit layout;
(c) if at least one predeterminable condition is not satisfied,
(c1) determining position data for at least one circuit part of the circuit layout for which at least one predeterminable condition is not satisfied; and
(d) carrying out a simulation for the at least one circuit part determined in step (c), in order to obtain a simulation result.

21. The method as claimed in claim 20, wherein step (c) further comprises:
(c2) emitting the position data to a user.

22. The method as claimed in claim 20, wherein step (c) further comprises:
(c3) emitting an error message, which preferably indicates which of the predeterminable conditions is not satisfied by the circuit part.

23. The method as claimed in claim 20, wherein step (c) further comprises:
(c4) classifying errors in predeterminable error classes.

24. The method as claimed in claim 20, wherein step (c) is carried out for essentially all of the parts of the circuit layout for which at least one predeterminable condition is not satisfied.

25. The method as claimed in claim 20, wherein step (d) is carried out essentially directly following the completion of step (c).

26. The method as claimed in claim 20, wherein step (d) further comprises:
(d1) reading a predeterminable input from a user; and
(d2) carrying out the simulation using the user input.

27. The method as claimed in claim 26, wherein the user input is a selection of at least one circuit part determined in step (c), and the simulation is carried out for the selected part or parts.

28. The method as claimed in claim 24, wherein the user input is a selection of at least one error class, and the simulation is carried out for those parts of the circuit layout which are associated with the selected error class or classes.

29. The method as claimed in claim 23, wherein step (c4) further comprises defining a representative of an error class, and carrying out the simulation for the representative of the selected error class or classes.

30. The method as claimed in claim 20, wherein step (d) further comprises:
(d3) selecting a simulation area which essentially contains the at least circuit part determined in step (c); and
(d4) carrying out a simulation on the simulation area selected in step (d3).

31. The method as claimed in claim 30, further comprising presetting the size and/or position of the simulation area.

32. The method as claimed in claim 30, wherein step (d3) further comprises reading a user input, by means of which the size and/or position of the simulation area is defined.

33. The method as claimed in claim 20, wherein steps (a) to (d) are carried out during the creation of the layout.

34. The method as claimed in claim 20, further comprising reading a user input which indicates that a check should be carried out, and steps (a) to (d) are carried out in response to the user input.

35. The method as claimed in claim 20, further comprising:
(e) recording a change to the circuit layout by the user; and
then carrying out steps (b) to (d).

36. The method as claimed in claim 35, wherein steps (a) to (e) are carried out using the circuit layout in a first data format, and the method further comprises:
(f) preparing the circuit layout that has been created for conversion of the circuit layout to a second data format, which is used for further processing.

37. The method as claimed in claim 36, wherein the second format is a graphical display streamer format.

38. A computer program product for checking a circuit layout for a semiconductor apparatus, which product comprises program parts for carrying out the method as claimed in claim 20.

39. An apparatus for checking a circuit layout for a semiconductor apparatus, comprising:
a device configured to record a circuit layout that has been created;
a device configured to carry out a test to determine whether predeterminable conditions are satisfied in the circuit layout;
a device configured to determine position data of at least one circuit part of the circuit layout for which at least one predeterminable condition is not satisfied; and
a device configured to carry out a simulation for the at least one determined circuit part, in order to obtain a simulation result.
